(19) United States
(12) Patent Application Publication
(10) Pub. No.: US 2020/0360742 A1
(43) Pub. Date: Nov. 19, 2020

(54) Friendship with Fire

(71) Applicant: Mohammad Najeeb Nazhand, Sacramento, CA (US)

(72) Inventor: Mohammad Najeeb Nazhand, Sacramento, CA (US)

(21) Appl. No.: 16/409,890

(22) Filed: May 13, 2019

(51) Int. Cl. A62C 3/02

(52) U.S. Cl. CPC A62C 3/025

(57) ABSTRACT

The present invention discloses a fire extinguishing device to reduce or extinguish a fire in a specific area through a helicopter. The main structure of fire extinguisher ball plate is of steel boxes with a separator in-between. The operator will use computer monitor and cameras to import wireless cameras pictures and area temperature in helicopter before dropping fire extinguisher ball in the specific area and can drop balls after evaluating the fire volume in the area from different cells of plate

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to fire safety devices, and particularly to a fire extinguishing ball that can be safely deployed into difficult to reach areas. More particularly, the present invention relates to a device that directionally disburses an extinguishing agent through the use of an explosive charge.

### Description of the Related Art

The most extensive disasters nowadays which damage our global environment and threaten life are forest fires occurring seasonally, by which more and more greenery is destroyed and life is endangered. The destruction of forests and elements of life by fires leads to ecological damage. Extensive fires also result in abandonment of mountainous areas by populations moving to plains and large cities which are connected with increases in water consumption, resulting to biological damage and to water balance alterations which may result to changes in face of the Planet. These changes of habitat have resulted to in the abandonment of the vast mountainous areas which largely control the water balance and the biological action on the Earth.

One of the methods to control forest fires is the use of helicopter in hovering above the fire while dispensing a fire extinguishing substance there from. The helicopter delivers fairly sizable quantities of water to the scene of a fire from a nearby lake or other body of water. For this purpose, a large container may be suspended beneath the helicopter from its cargo hook, with the quantity of water corresponding to the load-carrying capabilities of the helicopter.

Further it is obvious that water is the best and effective natural material in these kinds of fires extinguishing. However most quantity of the sprinkled water evaporates before causing any significant influence on the flame due to the high temperature of the flames. Usually the distance between fires and water resources are too far. Therefore water will be provided with delays in the next steps. Thus the total controlling of the flames using water as a fire extinguishing medium will be fruitless and the fire continues its expansion without any restrictions.

Hence there is a need for a fire fighting system that would eliminate the time of flight to a water source, reduce water refilling time and efficiently flight back to the fire.

A number of prior art devices are available in the art to provide temporary relief in the vicinity in which they are utilized. For example U.S. Pat. No. 3,980,139 to Kirk is one such device. The Kirk device provides a bomb that can be detonated within a fire. This device employs an ‘automatic heat triggered’ detonation means, and therefore, requires a possibly random period of time before detonation may occur. Further, due to extreme heat, the device may false trigger at an inappropriate time. The Kirk device also includes a glass cylinder (to hold a volume of extinguishing agent) “that can be readily fragmented so as to disperse its chemical content in all directions”. The use of this dispersal arrangement may prove to be hazardous to nearby persons when the device is detonated. A device with a safer and more directional disbursement would be useful.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved way to extinguish fire. The invention is light and portable which could extinguish the initial fire. It is made up of water-proof plastic shell and filled-up with harmless environmental powder. The helicopter will carry fire extinguisher balls on plates. And the proposed machine will throw the fire extinguisher ball on the fire zone area. When thrown or rolled into the fire. it will get burst and extinguish the fire immediately.

It is another objective of the invention to provide technology which will be self-activating handheld extinguishing device.

It is further the objective of the invention to establish in this portion of the disclosure that the present invention is a single-use device, which is environmentally friendly in its basic construction, and leaves little more residue than the expended fire extinguishing/suppressant chemicals employed with the device, when actuated.

It is also the objective of the low-cost, easily manufactured, effective fire-fighting device which is, a low mass, inexpensively manufacturable containment vessel, with a maximum of fire-retardant chemical agent within such a device.

It is another objective of the invention to provide a fire extinguisher ball plate with steel boxes which have a space for 316 fire extinguisher ball 4 or 10 kg each. The number of balls or the weight however is not restricted and might be increased or decreased depending on the functionality.

It is further the objective of the invention that the helicopter will pick up the plate and take it to the fire zone area to be dispersed on the fire. The plate would be hanging down from the helicopter. Fire extinguisher ball dropping off system would be controlled from the helicopter by wireless computerized system with camera to see the fire zone clearly, then to drop the fire extinguisher ball on target location. In-case of need for reining the helicopter will get back for refill.

The invention denotation mechanism can be used for fighting forest fires so a ball can he exploded at the top of ablaze trees and the other one on the bottom of lighted trees to control fire both ways from upside to down. The invention can use in similar way to control fire in commercial and residential buildings also where the helicopter can drop balls from the top on the building. The said machine is automatic filling fire extinguisher balls to the plate from the storage building.

A further object is to provide an assembly that is simple, rapidly adjusted and easy to use and an assembly that is economical in cost to manufacture.

It is a further object of present invention is contemplated to be configured as a reusable device that may be later reloaded with a new balls and another volume extinguishing agent.

Still yet another object of the present invention is to provide a new and improved guided adjustable microphone stand which provides in the apparatuses and methods of the prior art some of the advantages thereof, while simultaneously overcoming some of the disadvantages normally associated therewith.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is an exemplary front illustration of the invention.

FIG. 200 shows spaces for fire extinguisher balls.

FIG. 300 shows eyebolts to secure the invention.

FIG. 400 shows helicopter taking the invention to the desired location or fire area.

FIG. 500 shows typography of extinguisher ball.

FIG. 600 shows overall structure of the loading base.

FIG. 700 shows plate drifting at the desired location.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to invent a machine to control and turn off fire by shortest time and save human life, homes and environment.

As per preferred embodiment of the invention, The fire extinguishing ball, provides a safe means of extinguishing fires in typically inaccessible or hard to reach areas.

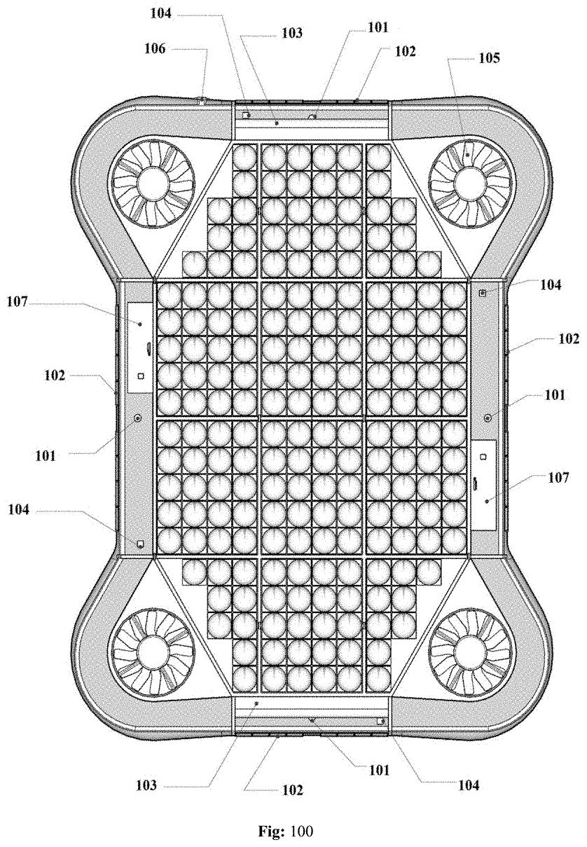

Referring now to FIG. 100, there is illustrated an exploded view of an embodiment of the fire extinguishing device. The invention would usually be of steel box which would be fixed with eyebolts 301. There would be cameras 101 with wireless computerized system and exporting data system next to safety Flashlight 102. There are also batteries 103 for supporting electricity for the invention. There are also multiple sensors 104 for area temperature for identifying the intensity. In-addition there are also Drone systems 105 for opening doors for dropping off the fire extinguisher ball. There are also multiple charging ports 106 to facilitate the charging of device. Also there is a space for communication panel box 107 for electrical connection wires, conduit and for connection of doors to the panel box and battery.

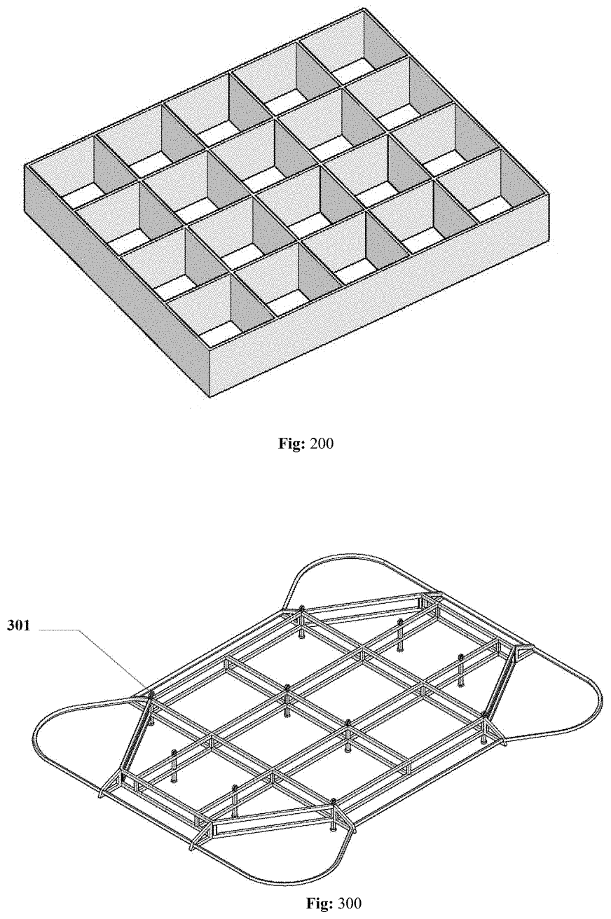

FIG. 200 shows the panels for carrying balls. FIG. 300 shows how the final invention would be joint with screw bolts.

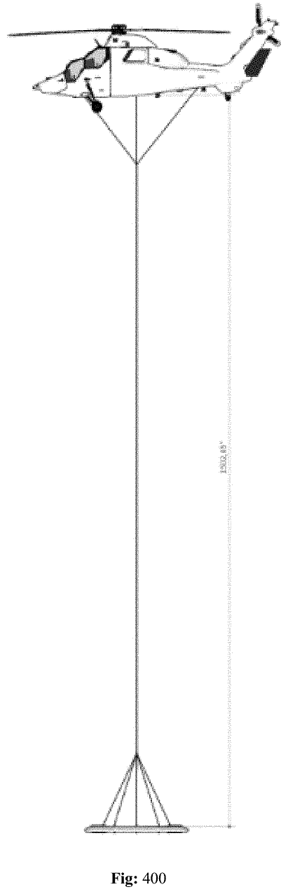

FIG. 400 is a practical demonstration of how the plate with fire extinguishers ball will be taken to places when in need.

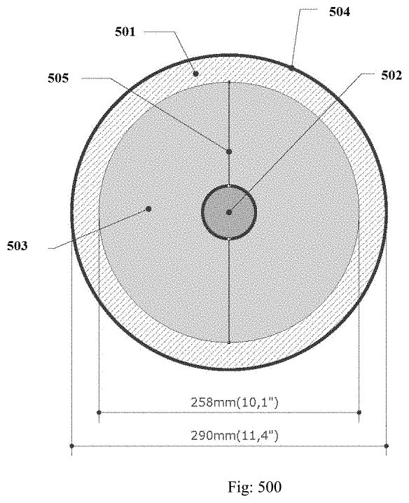

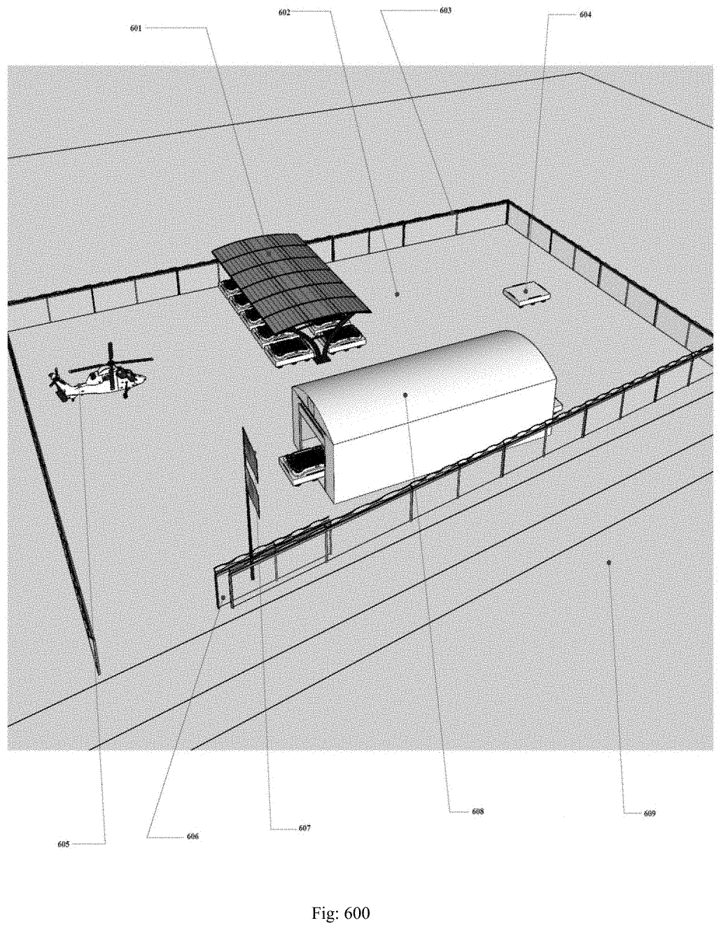

FIG. 500 shows typesetting of fire extinguishers ball. The first outer layer 504 is of film wrapping and label PEC/PVC. Then there is space 501 for Foam Non CFC. Inside the sphere there is space for extinguishing powder 503. Then there is plastic PVC for support 505 and wireless chip control charge 502. FIG. 600 shows the overall structure which shows fire extinguisher storage building area which consist of battery charging area 601 for the plate. A vacant area 602 for the movement. Side walls 603 and carrier wheel 604. It also shows helicopter 605 which will transfer the plate. A gate 606 with some country flags 607. A fire extinguisher ball storage building 608 beside the road 609.

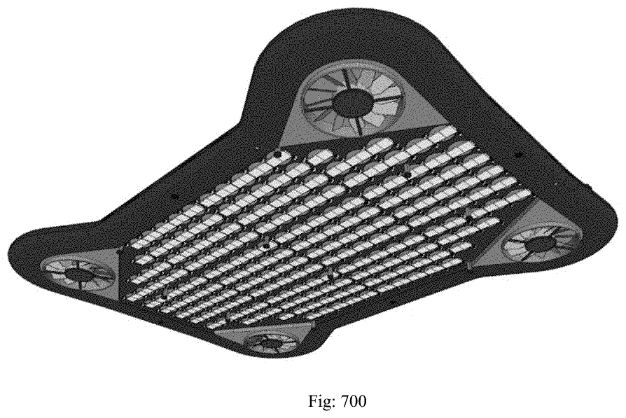

FIG. 700 is a practical demonstration of plate with balls drifting on the desired location ready to fire balls.

As per additional embodiment, this technology will have best information from the plate cameras and the person monitoring can see the fire area more clearly and can signal even if there is a life in danger.

It is to be understood that the fire extinguishing ball encompasses a variety of alternatives. For example, the fire extinguishing ball can be constructed in a variety of sizes, depending on the needs of the user. Moreover, the body can contain specific fire extinguishing agents for specific types of fires. The said machine is automatic filling fire extinguisher balls to the plate from the storage building.

An additional embodiment of the present invention is an explosive charge possibly located within the cavity of the disbursement container near the bottom end is substantially covered by the fire extinguishing agent. When the explosive charge is detonated by one of a number of suitable detonation means, the associated explosive discharge forces the extinguishing agent out of the disbursement container in an upward direction to subsequently shower down upon the flames of a fire in the vicinity of the fire extinguishing device to, at least in part, extinguish the fire in a localized area near the site of the detonation (i.e., in the general vicinity of the fire extinguishing device). Such denotation mechanism can be used for fighting forest fires so a ball can be exploded at the top of ablaze trees and the other one on the bottom of lighted trees to control fire both ways from upside to down. The invention can use in similar way to control fire in commercial and residential buildings also where the helicopter can drop balls from the top on the building.

The invention has plate carriers (wheelbarrow) which are moveable and controlled by remote control and is chargeable. The carriers will take the empty plate to the building and bring the fill one from inside of the building to other by remote control system. There are battery charging area and steel top cover parking area for plates as shown in FIG. 600.

The assembly is proposed to be made of durable material and consist of following parts,

### Plate Material

1—Main Structure is steel Box
2—Partition wall between each cells of fire extinguisher balls are fire residence plastic
3—Motors for opening doors for dropping off of fire extinguisher ball
4—Fire and Air resident Aluminum Sheet for covering plate and other parts of plate
5—4 camera with wireless computerized system and exporting date system
6—4 sensors for area temperature
7—Safety Flashlight at 4 sides of plate
8—Tension cable for hanging
9—Electrical panel box
10—Communication panel box
11—Electrical materials wire, conduit for connection of doors to the panel box and battery
12—2 batteries for supporting electricity for plate

### Storage Area Technology,

1—Fire extinguisher ball storage building
2—Computerized fire extinguisher ball filling system to the plate technology
3—Elevator inside storage building for fire extinguisher ball loading system technology
4—Plate carriers or wheelbarrow during loading and moving computerized system by wireless remote control system
5—Battery charging area for plate and carriers (plate wheelbarrow) in storage area
6—Maintenance building for plate and carriers (plate wheelbarrow) repair and fixing

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A fire extinguishing ball plate with steel boxes which have a space for fire extinguisher balls which are fitted in the plate and are transported through the helicopter,

II: Fire extinguisher ball dropping off system would be controlled by wireless computerized system with camera to see the fire zone clearly, then to drop the fire extinguisher ball on target location. In-case of need for refilling the helicopter will get back for refill.

III: Device according to claim I wherein the plate is launched from a helicopter.
